(19) United States
(12) Patent Application Publication
(10) Pub. No.: US 2010/0136074 A1
(43) Pub. Date: Jun. 3, 2010

(54) BIOCIDIC TEXTILES AND FABRICS

(75) Inventors: Shmuel Bukshpan, Ramat Ha-Sharon (IL); Gleb Zilberstein, Rechovot (IL)

Correspondence Address: The Law Office of Michael E. Kondoudis, 888 16th Street, N.W., Suite 800, Washington, DC, 20006, US

(73) Assignee: OPLON B.V., Delft (NL)

(21) Appl. No.: 12/598,430

(22) PCT Filed: Apr. 3, 2008
(86) PCT No.: PCT/IL08/00469

§ 371 Date: Nov. 19, 2009

Related U.S. Application Data
(60) Provisional application No. 60/924,153, filed on May 1, 2007.

(51) Int. Cl. A01N 25/34; B05D 5/12; A01P 1/00

(52) U.S. Cl. 424/404; 424/402; 427/58

(57) ABSTRACT

It is in the scope of the invention to disclose a biocidic textiles and fabrics, comprising at least one insoluble proton sink or source (PSS). The textiles and fabrics is provided useful for killing living target cells (LTCs), or otherwise disrupting vital intracellular processes and/or intercellular interactions of the LTC upon contact; the PSS comprising (i) proton source or sink providing a buffering capacity; and (ii) means providing proton conductivity and/or electrical potential; wherein the PSS is effectively disrupting the pH homeostasis and/or electrical balance within the confined volume of the LTC and/or disrupting vital intercellular interactions of the LTCs while efficiently preserving the pH of the LTCs' environment.

### FIELD OF THE INVENTION

The present invention pertains to antimicrobial textiles and fabrics adapted for killing target living cells. More specifically, to antimicrobial textiles and fabrics and methods for killing living target cells, or otherwise disrupting vital intracellular processes and/or intercellular interactions of the cells, while efficiently preserving the pH of the cells environment.

### BACKGROUND OF THE INVENTION

Microbial infestation poses danger to both living and non living matters. Obnoxious smell form the inner garments such as socks, spread of diseases, staining and degradation of textiles are some of the detrimental effects of bad microbes. Though the use of antimicrobials have been known for the decades, it is only in the recent couple of years several attempts have been made on finishing textiles with antimicrobial compounds. The consumers are now increasingly aware of the hygienic life style and there is a necessity and expectation for a wide range of textile products finished with antimicrobial properties. The new developments such as non-leaching type of finishes would help reduce the ill effects and possibly could comply with the statutory requirements imposed by regulating agencies. This paper reviews ways and means of finishing textiles and assessing their antimicrobial properties.

The inherent properties of the textile fibers provide room for the growth of micro-organisms. Besides, the structure of the substrates and the chemical processes may induce the growth of microbes. Humid and warm environment still aggravate the problem. Infestation by microbes cause cross infection by pathogens and development odors where the fabric is worn next to skin. In addition, the staining and loss of the performance properties of textile substrates are the results of microbial attack. Basically, with a view to protect the wearer and the textile substrate itself antimicrobial finish is applied to textile materials.

### Necessity of Antimicrobial Finishes

Antimicrobial treatment for textile materials is necessary to fulfill the following objectives: To avoid cross infection by pathogenic micro-organisms; To control the infestation by microbes; To arrest metabolism in microbes in order to reduce the odor formation; and To safeguard the textile products from staining, discoloration and quality deterioration.

### Requirements for Antimicrobial Finish

Textile materials in particular, the garments are more susceptible to wear and tear. It is important to take into account the impact of stress strain, thermal and mechanical effects on the finished substrates. The following requirements need to be satisfied to obtain maximum benefits out of the finish: Durability to washing, dry cleaning and hot pressing; Selective activity to undesirable microorganisms; Should not produce harmful effects to the manufacturer, user and the environment; Should comply with the statutory requirements of regulating agencies; Compatibility with the chemical processes; Easy method of application; No deterioration of fabric quality; Resistant to body fluids; and Resistant to disinfections/sterilization.

### Antimicrobial Finishing Methodologies

The antimicrobial agents can be applied to the textile substrates by exhaust, pad-dry-cure, coating, spray and foam techniques. The substances can also be applied by directly adding into the fiber spinning dope. It is claimed that the commercial agents can be applied online during the dyeing and finishing operations. Various methods for improving the durability of the finish include: Insolubilization of the active substances in/on the fiber; Treating the fiber with resin, condensates or cross linking agents; Microencapsulation of the antimicrobial agents with the fiber matrix; Coating the fiber surface; Chemical modification of the fiber by covalent bond formation; and Use of graft polymers, homo polymers and/or copolymerization on to the fiber.

### Mechanism of Antimicrobial Activity

Negative effect on the vitality of the microorganisms is generally referred to as antimicrobial. The degree of activity is differentiated by the term “cidal” which indicates significant destruction of microbes and the term “static” represents inhibition of microbial growth without much destruction.

The activity which affects the bacteria is known as antibacterial and that of fungi is antimycotic. The antimicrobial substances function in different ways. In the conventional leaching type of finish, the species diffuse and poison the microbes to kill. This type of finish shows poor durability and may cause health problems. The non-leaching type or bio-static finish shows good durability and may not provoke any health problems. A large number of textiles with antimicrobial finish function by diffusion type. The rate of diffusion has a direct effect on the effectiveness of the finish.

For example, in the ion exchange process, the release of the active substances is at a slower rate compared to direct diffusion and hence, has a weaker effect. Similarly, in the case of antimicrobial modifications where the active substances are not released from the fibre surface and so less effective. They are active only when they come in contact with microorganisms.

These so called new technologies have been developed by considering the medical, toxicological and ecological principles. The antimicrobial textiles can be classified into two categories, namely, passive and active based on their activity against microorganisms. Passive materials do not contain any active substances but their surface structure (Lotus effect) produces negative effect on the living conditions of microorganisms (Anti-adhesive effect). Materials containing active antimicrobial substances act upon either in or on the cell.

Antimicrobial Substances and their Effect

Many antimicrobial agents used in the textile industry are known from the food stuff and cosmetics sector. These substances are incorporated with textile substrates comparatively at lower concentrations. It must be ensured that these substances are not only permanently effective but also that they are compatible with skin and the environment. A wide palette of antimicrobial compounds is now in use but differ in their mode of action. The following list demonstrates the polyvalent effect of the various antimicrobial substances:

Materials with active finishes contain specific active antimicrobial substances, which act upon microorganisms either on the cell, during the metabolism or within the core substance (genome). However, due to the very specific nature of their effect, it is important to make a clear distinction between antibiotics and other active substances which have abroad range of uses.

Oxidizing agents such as aldehydes, halogens and proxy compounds attack the cell membrane, get into the cytoplasm and affect the enzymes of the microorganisms.

Coagulants, primarily alcohols irreversibly denature the protein structures. Radical formers like halogens, isothiazones and peroxo compounds are highly reactive due to the presence of free electrons. These compounds virtually react with all organic structures in particular oxidizing thiols in amino acids. Even at the lowest level of concentrations, these substances pose particular risk to nucleic acids by triggering mutations and dimerization.

One of the most durable type of antimicrobial products is based on a diphenyl ether (bis-phenyl) derivative known as either 2,4,4′-trichloro-2′ hydroxy dipenyl ether or 5-chloro-2-(2,4-dichlorophenoxyl) phenol. Triclosan products have been used for more than 25 years in hospitals and personal care products such as antimicrobial soap, toothpaste and deodorants. Triclosan inhibits growth of microorganisms by using a electro chemical mode of action to penetrate and disrupt their cell walls. When the cell walls are penetrated, leakage of metabolites occurs and other cell functions are disabled, thereby preventing the organism from functioning or reproducing. The triclosan when incorporated within a polymer migrates to the surface, where it is bound. Because, it is not water-soluble, it does not leach out, and it continuously inhibits the growth of bacteria in contact with the surface using barrier or blocking action.

Quaternary ammonium compounds, biguanides, amines and glucoprotamine show poly cationic, porous and absorbent properties. Fibers finished with these substances bind micro organisms to their cell membrane and disrupt the lipopolysaccharide structure resulting in the breakdown of the cell.

Complexing metallic compounds based on metals like cadmium, silver, copper and mercury cause inhibition of the active enzyme centers (inhibition of metabolism). Amongst these, the silver compounds are very popular and already been used in the preparation of antimicrobial drinking water.

Chitosan is an effective natural antimicrobial agent derived from Chitin, a major component in crustacean shells. Coatings of Chitosan on conventional fibers appear to be the more realistic prospect since they do not provoke an immunological response. Fibers made from Chitosan are also available in the market place.

Natural herbal products can be used for antimicrobial finishes since, there is a tremendous source of medicinal plants with antimicrobial composition to be the effective candidates in bringing out herbal textiles.

### Commercial Antimicrobial Agents and Fibres

Thomsan Research Associates markets a range of antimicrobials under the trade name Ultrafresh™ for the textile and polymer industry. Ultrafresh™ products were developed to be used in normal textile processes. Most Ultrafresh™ treatments are non-ionic and are compatible with a wide range of binders and finishes. To incorporate antibacterial into high temperature fibres like polyester and nylon, it is necessary to use an inorganic antimicrobial like Ultrafresh™ CA-16 or PA-42. These must be added as a special master batch to the polymer mixture before the extrusion process. For fibres such as polypropylene which are extruded at lower temperatures, it is possible to use organic antimicrobials such as Ultrafresh™ Nm-100, Dm-50 or XQ-32.

In the case of Rossari's Fabshield with AEGIS microbe shield program, the cell membrane of the bacteria gets ruptured when the microbes come in contact with the treated surface.

Thus, preventing consumption of antimicrobial over a period of time and remain functional throughout the life of the product. The active substance 3-Trimethoxy silyl propyl dimethyl octadecyl ammonium chloride gets attached to the substrate either through bond formation on the surface or by

micropolymersing and forming a layer on the treated surface; the antimicrobial agent disrupts the cell membrane of the microbes through physical and ionic phenomena.

Ciba Speciality Chemicals markets Tinosan AM 110 as a durable antimicrobial agent for textiles made of polyester and polyamide fibers and their blends with cotton, wool or other fibers. Tinosan contains an active antimicrobial (2,4,4′-Trichloro-2′-hydroxyl-dipenylether) which behaves like a colorless disperses dye and can be exhausted at a very high exhaustion rate on to polyester and polyamide fibers when added to the dye bath.

Clariant markets the Sanitized range of Sanitized AG, Switzerland for the hygienic finish of both natural and synthetic fibers. The branded Sanitized range functions as a highly effective bacteriostatic and fungistatic finishes and can be applied to textile materials such as ladies hosiery and tights. Actigard finishes from Clariant are used in carpets to combat action of bacteria, house dust mites and mould fungi.

Avecia's Purista-branded products treated with Reputex 20 which is based on poly (hexamethylene) biguanide hydrochloride (PHMB) claimed to posses a low mammalian toxicity and broad spectrum of antimicrobial activity. PHMB is particularly suitable for cotton and cellulosic textiles and can be applied to blends of cotton with polyester and nylon.

In addition to the aforesaid antimicrobial agents, the fibers derived from synthetic with built-in antimicrobial properties are listed in Table 1.

| Polymer | Polymer Company | Brand |
|---|---|---|
| Polyester | Trevira Montefibre, | Trevira Bioactive Terital |
| | Brilen | SANIWEAR Bacterbril |
| Polyacryl | Accordis, Sterling | Amicor, Biofresh |
| Polyamide | Kaneba | Livefresh, R-STAT, Meryl |
| | R-STAT | Skinlife |
| | Nylstar | |
| Polypropylene | Asota | Asota AM Sanitary |
| Polyvinyl chloride | Rhovyl | Rhovyl's as Aantibacterial |
| Regenerated cellulose | Zimmer AG | Sea Cell Activated |

### Benefits of Antimicrobial Textiles

A wide range textile product is now available for the benefit of the consumer. Initially, the primary objective of the finish was to protect textiles from being affected by microbes particularly fungi. Uniforms, tents, defense textiles and technical textiles, such as, geotextiles have therefore all been finished using antimicrobial agents. Later, the home textiles, such as, curtains coverings, and bath mats came with extended to textiles used for outdoor, healthcare sector, sports and leisure. Novel technologies in antimicrobial finishing are successfully employed in non-woven sector especially in medical textiles. Textile fibers with built-in antimicrobial properties will also serve the purpose alone or in blends with other fibers. Bioactive fiber is a modified form of the finish which includes chemotherapeutics in their structure, i.e., synthetic drugs of bactericidal and fungicidal qualities. These fibers are not only used in medicine and health prophylaxis applications but also for manufacturing textile products of daily use and technical textiles. The field of application of the bioactive fibers includes sanitary materials, dressing materials, surgical threads, materials for filtration of gases and liquids, air conditioning and ventilation, constructional materials, special materials for food industry, pharmaceutical industry, footwear industry, clothing industry, automotive industry etc.

With advent of new technologies, the growing needs of the consumer in the wake of health and hygiene can be fulfilled without compromising the issues related to safety, human health and environment. Taping new potential antimicrobial substances, such as, those described above can considerably minimize the undesirable activities of the antimicrobial products. Scientists all over the globe are working in the area and few of them reported to have used antimicrobial finishes and fluoro-chemicals to make the fabric having antimicrobial properties. Chitosan and fluoro-polymers reported to be most suitable finishing agents for medical wears with barriers against microorganisms and blood.

To carve a niche for textile materials, this kind of value adding finishes are the need of the hour. In this context, an entire new group of antimicrobial materials and compositions has been developed and described in PCT application No. PCT/IL2006/001262. These materials and compositions exert their cell killing effect via a totally different mechanism of action as compared with the above described prior art. The antimicrobial effect of the materials and compositions of the current invention is achieved via a titration-like process in which the microbial cell is coming into contact with strong acids and/or strong basic buffers and the like: encapsulated strong acidic and strong basic buffers in solid or semi-solid envelopes, solid ion-exchangers (SIEx), ionomers, coated-SIEx, high-cross-linked small-pores SIEx, Filled-pores SIEx, matrix-embedded SIEx, Ionomeric particles embedded in matrices, mixture of anionic (acidic) and cationic (basic) SIEx etc.: This process leads to disruption of the cell pH-homeostasis and consequently to cell death.

Chemically active textile materials and ion-exchange fifers are known to the art. For example, Fiban®, Vion® and Ionex®. However, these materials are being used for water and air treatment or personal protection against chemical contaminations but not as antimicrobial.

Hence, biocidic textiles and fabrics, adapted for killing living target cells (LTCs), or otherwise disrupting vital intracellular processes and/or intercellular interactions of the LTC upon contact, while efficiently preserving the pH of the LTCs' environment are still an unmet need.

### SUMMARY OF THE INVENTION

It is in the scope of the invention to disclose a biocidic textiles and fabrics, comprising at least one insoluble proton sink or source (PSS). The textiles and fabrics is provided useful for killing living target cells (LTCs), or otherwise disrupting vital intracellular processes and/or intercellular interactions of the LTC upon contact; the PSS comprising (i) proton source or sink providing a buffering capacity; and (ii) means providing proton conductivity and/or electrical potential; wherein the PSS is effectively disrupting the pH homeostasis and/or electrical balance within the confined volume of the LTC and/or disrupting vital intercellular interactions of the LTCs while efficiently preserving the pH of the LTCs' environment.

It is in the scope of the invention wherein the PSS is an insoluble hydrophobic, either anionic, cationic or zwitterionic charged polymer, useful for killing living target cells (LTCs), or otherwise disrupting vital intracellular processes and/or intercellular interactions of the LTC upon contact. It is additionally or alternatively in the scope of the invention, wherein the PSS is an insoluble hydrophilic, anionic, cationic or zwitterionic charged polymer, combined with water-immiscible polymers useful for killing living target cells (LTCs), or otherwise disrupting vital intracellular processes and/or intercellular interactions of the LTC upon contact. It is further in the scope of the invention, wherein the PSS is an insoluble hydrophilic, either anionic, cationic or zwitterionic charged polymer, combined with water-immiscible either anionic, cationic of zwitterionic charged polymer useful for killing living target cells (LTCs), or otherwise disrupting vital intracellular processes and/or intercellular interactions of the LTC upon contact.

It is also in the scope of the invention wherein the PSS is adapted in a non-limiting manner, to contact the living target cell either in a bulk or in a surface; e.g., at the outermost boundaries of an organism or inanimate object that are capable of being contacted by the PSS of the present invention; at the inner membranes and surfaces of microorganisms, animals and plants, capable of being contacted by the PSS by any of a number of transdermal delivery routes etc; at the bulk, either a bulk provisioned with stirring or not etc.

It is further in the scope of the invention wherein either (i) a PSS or (ii) an article of manufacture comprising the PSS also comprises an effective measure of at least one additive.

It is also in the scope of the invention to disclose the textiles and fabrics as defined above, wherein the proton conductivity is provided by water permeability and/or by wetting, especially wherein the wetting is provided by hydrophilic additives.

It is also in the scope of the invention to disclose the textiles and fabrics as defined above, wherein the proton conductivity or wetting is provided by inherently proton conductive materials (IPCMs) and/or inherently hydrophilic polymers (IHPs), selected from a group consisting of sulfonated tetrafluortheylene copolymers; sulfonated materials selected from a group consisting of silica, polythion-ether sulfone (SPTES), styrene-ethylene-butylene-styrene (S-SEBS), polyether-ether-ketone (PEEK), poly (arylene-ether-sulfone) (PSU), Polyvinylidene Fluoride (PVDF)-grafted styrene, polybenzimidazole (PBI) and polyphosphazene; proton-exchange membrane made by casting a polystyrene sulfonate (PSSnate) solution with suspended micron-sized particles of cross-linked PSSnate ion exchange resin; commercially available Nafion™ and derivatives thereof.

It is another object of the invention to disclose the PSS as defined in any of the above, wherein the PSS is constructed as a conjugate, comprising two or more, either two-dimensional (2D) or three-dimensional (3D) PSSs, each of which of the PSSs consisting of materials containing highly dissociating cationic and/or anionic groups (HDCAs) spatially organized in a manner which efficiently minimizes the change of the pH of the LTC's environment. Each of the HDCAs is optionally spatially organized in specific either 2D, topologically folded 2D surfaces, or 3D manner efficiently which minimizes the change of the pH of the LTC's environment; further optionally, at least a portion of the spatially organized HDCAs are either 2D or 3D positioned in a manner selected from a group consisting of (i) interlacing; (ii) overlapping; (iii) conjugating; (iv) either homogeneously or heterogeneously mixing; and (iv) tiling the same.

It is acknowledged in this respect to underline that the term HDCAs refers, according to one specific embodiment of the invention, and in a non-limiting manner, to ion-exchangers, e.g., water immiscible ionic hydrophobic materials.

It is also in the scope of the invention to disclose the textiles and fabrics as defined above, wherein the PSS is effectively disrupting the pH homeostasis within a confined volume while efficiently preserving the entirety of the LTC's environment; and further wherein the environment's entirety is characterized by parameters selected from a group consisting of the environment functionality, chemistry; soluble's concentration, possibly other then proton or hydroxyl concentration; biological related parameters; ecological related parameters; physical parameters, especially particles size distribution, rehology and consistency; safety parameters, especially toxicity, otherwise LD₅₀ or ICT₅₀ affecting parameters; olphactory or organoleptic parameters (e.g., color, taste, smell, texture, conceptual appearance etc); or any combination of the same.

It is also in the scope of the invention to disclose the textiles and fabrics as defined above, wherein the textiles and fabrics are provided useful for disrupting vital intracellular processes and/or intercellular interactions of the LTC, while both (i) effectively preserving the pH of the LTC's environment and (ii) minimally affecting the entirety of the LTC's environment such that a leaching from the PSS of either ionized or neutral atoms, molecules or particles to the LTC's environment is minimized.

It is well in the scope of the invention wherein the aforesaid leaching minimized such that the concentration of leached ionized or neutral atoms is less than 1 ppm. Alternatively, the aforesaid leaching is minimized such that the concentration of leached ionized or neutral atoms is less than less than 50 ppb. Alternatively, the aforesaid leaching is minimized such that the concentration of leached ionized or neutral atoms is less than less than 50 ppb and more than 10 ppb. Alternatively, the aforesaid leaching is minimized such that the concentration of leached ionized or neutral atoms is less than less than 10 but more than 0.5 ppb. Alternatively, the aforesaid leaching is minimized such that the concentration of leached ionized or neutral atoms is less than less than 0.5 ppb.

It is also in the scope of the invention to disclose the textiles and fabrics as defined above, wherein the textiles and fabrics are provided useful for disrupting vital intracellular processes and/or intercellular interactions of the LTC, while less disrupting pH homeostasis and/or electrical balance within at least one second confined volume (e.g., non-target cells or viruses, NTC).

It is also in the scope of the invention to disclose the textiles and fabrics as defined above, wherein the differentiation between the LTC and NTC is obtained by one or more of the following means (i) providing differential ion capacity; (ii) providing differential pH values; and, (iii) optimizing PSS to target cell size ratio; (iv) providing a differential spatial, either 2D, topologically folded 2D surfaces, or 3D configuration of the PSS; (v) providing a critical number of PSS' particles (or applicable surface) with a defined capacity per a given volume; and (vi) providing size exclusion means.

It is also in the scope of the invention to disclose the textiles and fabrics as defined above, wherein the textiles and fabrics are provided for killing target cells. The textiles and fabrics comprising at least one insoluble non-leaching PSS as defined in any of the above; the PSS, located on the internal and/or external surface of the textiles and fabrics, is provided useful, upon contact, for disrupting pH homeostasis and/or electrical balance within at least a portion of an LTC while effectively preserving pH & functionality of the surface.

It is also in the scope of the invention to disclose the textiles and fabrics as defined above, wherein the textiles and fabrics are having at least one external proton-permeable surface with a given functionality (e.g., electrical current conductivity, affinity, selectivity etc), the surface is at least partially composed of, or topically and/or underneath layered with a PSS, such that disruption of vital intracellular processes and/or intercellular interactions of the LTC is provided, while the LTC's environment's pH & the functionality is effectively preserved.

It is also in the scope of the invention to disclose the textiles and fabrics as defined above, wherein the textiles and fabrics comprising a surface with a given functionality, and one or more external proton-permeable layers, each of which of the layers is disposed on at least a portion of the surface; wherein the layer is at least partially composed of or layered with a PSS such that vital intracellular processes and/or intercellular interactions of the LTC are disrupted, while the LTC's environment's pH & the functionality is effectively preserved.

It is also in the scope of the invention to disclose the textiles and fabrics as defined above, wherein the textiles and fabrics comprising (i) at least one PSS; and (ii) one or more preventive barriers, providing the PSS with a sustained long activity; preferably wherein at least one barrier is a polymeric preventive barrier adapted to avoid heavy ion diffusion; further preferably wherein the polymer is an ionomeric barrier, and particularly a commercially available Nafion™.

It is acknowledged in this respect that the presence or incorporation of barriers that can selectively allow transport of protons and hydroxyls but not of other competing ions to and/or from the SIEx surface eliminates or substantially reduces the ion-exchange saturation by counter-ions, resulting in sustained and long acting cell killing activity of the materials and compositions of the current invention.

It is in the scope of the invention, wherein the proton and/or hydroxyl-exchange between the cell and strong acids and/or strong basic materials and compositions may lead to disruption of the cell pH-homeostasis and consequently to cell death. The proton conductivity property, the volume buffer capacity and the bulk activity are pivotal and crucial to the present invention.

It is further in the scope of the invention, wherein the pH derived cytotoxicity can be modulated by impregnation and coating of acidic and basic ion exchange materials with polymeric and/or ionomeric barrier materials.

It is also in the scope of the invention to disclose the textiles and fabrics as defined above, wherein the textiles and fabrics adapted to avoid development of LTC's resistance and selection over resistant mutations.

It is also in the scope of the invention to disclose the textiles and fabrics as defined above, wherein the textiles and fabrics designed as an insert, comprising at least one PSS, the insert is provided with dimensions adapted to ensure either (i) reversibly mounting or (ii) permanent accommodation of the insert within a predetermined article of manufacture.

It is also in the scope of the invention to disclose the textiles and fabrics as defined above, wherein the textiles and fabrics characterized by at least one of the following (i) regeneratable proton source or sink; (ii) regeneratable buffering capacity; and (iii) regeneratable proton conductivity.

It is also in the scope of the invention to disclose a method for killing living target cells (LTCs), or otherwise disrupting vital intracellular processes and/or intercellular interactions of the LTC being in a textiles and fabrics, textiles and fabrics. The method comprising steps of providing the textiles and fabrics with at least one PSS having (i) proton source or sink providing a buffering capacity; and (ii) means providing proton conductivity and/or electrical potential; contacting the LTCs with the PSS; and by means of the PSS, effectively disrupting the pH homeostasis and/or electrical balance within the LTC while efficiently preserving the pH of the LTC's environment.

It is another object of the invention to disclose a method as defined above, wherein the method further comprising a step of providing the PSS with inherently proton conductive materials (IPCMs) and/or inherently hydrophilic polymers (IHPs), especially by selecting the IPCMs and/or IHPs from a group consisting of sulfonated tetrafluoroethylene copolymers; commercially available Nafion™ and derivatives thereof.

It is another object of the invention to disclose a method as defined above, wherein the method further comprising steps of providing two or more, either two-dimensional (2D), topologically folded 2D surfaces, or three-dimensional (3D) PSSs, each of which of the PSSs consisting of materials containing highly dissociating cationic and/or anionic groups (HDCAs); and, spatially organizing the HDCAs in a manner which minimizes the change of the pH of the LTC's environment.

It is also in the scope of the invention to disclose the method as defined above, wherein the method further comprising steps of providing the textiles and fabrics with two or more, either two-dimensional (2D) or three-dimensional (3D) PSSs, each of which of the PSSs consisting of materials containing highly dissociating cationic and/or anionic groups (HDCAs); and, spatially organizing the HDCAs in a manner which minimizes the change of the pH of the LTC's environment.

It is also in the scope of the invention to disclose the method as defined above, wherein the method further comprising a step of spatially organizing each of the HDCAs in a specific, either 2D or 3D manner, such that the change of the pH of the LTC's environment is minimized.

It is also in the scope of the invention to disclose the method as defined above, wherein the step of organizing is provided by a manner selected for a group consisting of (i) interlacing the HDCAs; (ii) overlapping the HDCAs; (iii) conjugating the HDCAs; and (iv) either homogeneously or heterogeneously mixing the HDCAs and (v) tiling of the same.

It is also in the scope of the invention to disclose the method as defined above, wherein the method further comprising a step of disrupting pH homeostasis and/or electrical potential within at least a portion of an LTC by a PSS, while both (i) effectively preserving the pH of the LTC's environment; and (ii) minimally affecting the entirety of the LTC's environment; the method is especially provided by minimizing the leaching of either ionized or electrically neutral atoms, molecules or particles (AMP) from the PSS to the LTC's environment.

It is also in the scope of the invention to disclose the method as defined above, wherein the method further comprising steps of preferentially disrupting pH homeostasis and/or electrical balance within at least one first confined volume (e.g., target living cells or viruses, LTC), while less disrupting pH homeostasis within at least one second confined volume (e.g., non-target cells or viruses, NTC).

It is also in the scope of the invention to disclose the method as defined above, wherein the differentiation between the LTC and NTC is obtained by one or more of the following steps: (i) providing differential ion capacity; (ii) providing differential pH value; (iii) optimizing the PSS to LTC size ratio; and, (iv) designing a differential spatial configuration of the PSS boundaries on top of the PSS bulk; and (v) providing a critical number of PSS' particles (or applicable surface) with a defined capacity per a given volume and (vi) providing size exclusion means, e.g., mesh, grids etc.

It is further in the scope of the invention wherein either (i) a PSS or (ii) an article of manufacture comprising the PSS also comprises an effective measure of at least one additive.

It is another object of the invention to disclose an article of manufacture as defined in any of the above, designed and constructed as a member of a group consisting of bathers; membranes; filers; pads; meshes; nets; inserts; particulate matter; powders, nano-powders and the like; vehicles, carriers or vesicles consisting a PSS (e.g., liposomes with PSSs); doped, coated, immersed, contained, soaked, immobilized, entrapped, affixed, set in a column, solubilized, or otherwise bonded PSS-containing matter.

It is hence in the scope of the invention wherein one or more of the following materials are provided: encapsulated strong acidic and strong basic buffers in solid or semi-solid envelopes, solid ion-exchangers (SIEx), ionomers, coated-SIEx, high-cross-linked small-pores SIEx, Filled-pores SIEx, matrix-embedded SIEx, ionomeric particles embedded in matrices, mixture of anionic (acidic) and cationic (basic) SIEx etc.

It is another object of the invention to disclose the PSS as defined in any of the above, wherein the PSS are naturally occurring organic acids compositions containing a variety of carbocsylic and/or sulfonic acid groups of the family, abietic acid (C₂₀H₃₀O₂) such as colophony/rosin, pine resin and alike, acidic and basic terpenes.

### BRIEF DESCRIPTION OF THE DRAWINGS

In order to understand the invention and to see how it may be implemented in practice, a plurality of preferred embodiments will now be described, by way of non-limiting example only, with reference to the accompanying drawing, in which

FIG. 1 is illustrating Bacterial counts (CFU/ml) in TSB in the absence or the presence of the various antimicrobial-treated fabrics;

Fig. is 2, showing the bacterial counts (CFU/gr of cloth) in treated and non treated cotton fabrics after several washing cycles; and,

Fig. is 3, demonstrating antimicrobial activity of non-woven disposable fabric (polypropylene fabric) treated by coating method 1.

### DESCRIPTION OF THE PREFERRED EMBODIMENTS

The following specification taken in conjunction with the drawings sets forth the preferred embodiments of the present invention. The embodiments of the invention disclosed herein are the best modes contemplated by the inventors for carrying out their invention in a commercial environment, although it should be understood that various modifications can be accomplished within the parameters of the present invention.

The term ‘contact’ refers hereinafter to any direct or indirect contact of a PSS with a confined volume (living target cell or virus—LTC), wherein the PSS and LTC are located adjacently, e.g., wherein the PSS approaches either the internal or external portions of the LTC; further wherein the PSS and the LTC are within a proximity which enables (i) an effective disruption of the pH homeostasis and/or electrical balance, or (ii) otherwise disrupting vital intracellular processes and/or intercellular interactions of the LTC.

The terms ‘effectively’ and ‘effectively’ refer hereinafter to an effectiveness of over 10%, additionally or alternatively, the term refers to an effectiveness of over 50%; additionally or alternatively, the term refers to an effectiveness of over 80%. It is in the scope of the invention, wherein for purposes of killing LTCs, the term refers to killing of more than 50% of the LTC population in a predetermined time, e.g., 10 min.

The term ‘additives’ refers hereinafter to one or more members of a group consisting of biocides e.g., organic biocides such as tea tree oil, rosin, abietic acid, terpens, rosemary oil etc, and inorganic biocides, such as zinc oxides, cupper and mercury, silver salts etc, markers, biomarkers, dyes, pigments, radio-labeled materials, glues, adhesives, lubricants, medicaments, sustained release drugs, nutrients, peptides, amino acids, polysaccharides, enzymes, hormones, chelators, multivalent ions, emulsifying or de-emulsifying agents, binders, fillers, thickfiers, factors, co-factors, enzymatic-inhibitors, organoleptic agents, carrying means, such as liposomes, multilayered vesicles or other vesicles, magnetic or paramagnetic materials, ferromagnetic and non-ferromagnetic materials, biocompatibility-enhancing materials and/or biodegradating materials, such as polylactic acids and polyglutaminc acids, anticorrosive pigments, anti-fouling pigments, UV absorbers, UV enhancers, blood coagulators, inhibitors of blood coagulation, e.g., heparin and the like, or any combination thereof.

The term ‘particulate matter’ refers hereinafter to one or more members of a group consisting of nano-powders, micrometer-scale powders, fine powders, free-flowing powders, dusts, aggregates, particles having an average diameter ranging from about 1 nm to about 1000 nm, or from about 1 mm to about 25 mm.

The term ‘about’ refers hereinafter to ±20% of the defined measure.

The term ‘textiles’ refers hereinafter a non-limiting manner to all woven, machine or hand knitted goods or products produced from fibre materials, in which the fibres may be natural and/or synthetic. This term includes, inter alia, clothing articles, blankets, carpets and tapestries. Textiles may consist of a multiplicity of elements, in particular clothing articles from the field of outer clothing, in particular jackets, coats, shirts, blouses or pullovers are to be mentioned, which may consist of, for example, sleeves, collars, cuffs, clothing fronts and backs, and the like, it being in principle conceivable for individual elements not to consist of textile material, but of leather and the like. By the connection of a plurality of material or tissue cuts or elements by their edges, the textiles can be provided with the three-dimensional shame of a clothing article. Such clothing articles can furthermore be additionally provided with buttons, zip fasteners or the like. A further embodiment of the textiles consists in the material and/or tissue cuts being made up into blankets, tapestries or carpets. The design of textiles, as regards the shave, colour patterning or cut pattern, is almost entirely freely variable.

The term ‘fabrics’ refers hereinafter in a non-limiting manner to meshes and nettings. Microporous films may also be used. The fabric of a reinforcing substrate may be composed of synthetic fibers or filaments, glass yarns, non-corroding metal fibers, such as nickel fibers, or carbon fibers. The fibers, filaments or yarns should be ones to which the water-conducting polymer film adheres strongly. Suitable synthetic fibers include polyolefins, particularly polyethylene or polypropylene, and polyesters. The fibers may have organic or inorganic sizing agents or coupling agents applied, including polyvinylalcohol, starches, oil, polyvinylmethylether, acrylic, polyester, vinylsilane, aminosilane, titanate, and zirconate. Silicone-based lubricants are sometimes employed for greater tear strength. A microporous film may be composed of any synthetic polymer to which the humidity-conducting polymer adheres. In particular, the films may have a polyolefin composition, and more particularly, polyethylene. Films having a fluoropolymer composition may also be used.

The present invention also relates to materials, compositions and methods for treating yarns, fabrics and textiles, woven and non-woven, thereby, instilling them with long-lasting and long-acting antimicrobial properties.

The materials and compositions of the current invention include but not limited to all materials and compositions disclosed in PCT/IL2006/001262. The above mentioned materials and compositions of PCT/IL2006/001262 modified in such a way that these compositions are ion-selective by, for example: coating them with a selective coating, or ion-selective membrane; coating or embedding in high-cross-linked size excluding polymers etc. Strong acidic and strong basic buffers encapsulated in solid or semi-solid envelopes. SIEx particles—coated and non-coated, alone or in a mixture, embedded in matrices so as to create a pH-modulated polymer. SIEx particles—coated and non-coated, embedded in porous ceramic or glass water permeable matrices. Polymers which are alternately tiled with areas of high and low pH to create a mosaic-like polymer with an extended cell-killing spectrum.

In addition to ionomers disclosed in the above mentioned PCT/IL2006/001262, other ionomers can be used in the current invention as cell-killing materials and compositions. These may include, but certainly not limited to, for example: sulfonated silica, sulfonated polythion-ether sulfone (SPTES), sulfonated styrene-ethylene-butylene-styrene (S-SEBS), polyether-ether-ketone (PEEK), poly (arylene-ether-sulfone) (PSU), Polyvinylidene Fluoride (PVDF)-grafted styrene, polybenzimidazole (PBI) and polyphosphazene, proton-exchange membrane made by casting a polystyrene sulfonate (PSS) solution with suspended micron-sized particles of cross-linked PSS ion exchange resin.

It is in the scope of the invention, wherein the textiles and fabrics comprises an insoluble PSS in the form of a polymer, ceramic, gel, resin or metal oxide is disclosed. The PSS is carrying strongly acidic or strongly basic functional groups (or both) adjusted to a pH of about <4.5 or about >8.0. It is in the scope of the invention, wherein the insoluble PSS is a solid buffer.

It is also in the scope of the invention wherein material's composition is provided such that the groups are accessible to water whether they are on the surface or in the interior of the PSS. Contacting a living cell (e.g., bacteria, fungi, animal or plant cell) with the PSS kills the cell in a time period and with an effectiveness depending on the pH of the PSS, the mass of PSS contacting the cell, the specific functional group(s) carried by the PSS, and the cell type. The cell is killed by a titration process where the PSS causes a pH change within the cell. The cell is often effectively killed before membrane disruption or cell lysis occurs. The PSS kills cells without directly contacting the cells if contact is made through a coating or membrane which is permeable to water, H+ and OH− ions, but not other ions or molecules. Such a coating also serves to prevent changing the pH of the PSS or of the solution surrounding the target cell by diffusion of counterions to the PSS's functional groups. It is acknowledged in those respect that prior art discloses cell killing by strongly cationic (basic) molecules or polymers where killing probably occurs by membrane disruption and requires contact with the strongly cationic material or insertion of at least part of the material into the outer cell membrane.

It is also in the scope of the invention wherein an insoluble polymer, ceramic, gel, resin or metal oxide carrying strongly acid (e.g. sulfonic acid or phosphoric acid) or strongly basic (e.g. quaternary or tertiary amines) functional groups (or both) of a pH of about <4.5 or about >8.0 is disclosed. The functional groups throughout the PSS are accessible to water, with a volumetric buffering capacity of about 20 to about 100 mM H⁺/1/pH unit, which gives a neutral pH when placed in unbuffered water (e.g., about 5<pH> about 7.5) but which kills living cells upon contact.

It is also in the scope of the invention wherein the insoluble polymer, ceramic, gel, resin or metal oxide as defined above is coated with a barrier layer permeable to water, H+ and OH− ions, but not to larger ions or molecules, which kills living cells upon contact with the barrier layer.

It is also in the scope of the invention wherein the insoluble polymer, ceramic, gel, resin or metal oxide as defined above is provided useful for killing living cells by inducing a pH change in the cells upon contact.

It is also in the scope of the invention wherein the insoluble polymer, ceramic, gel, resin or metal oxide as defined above is provided useful for killing living cells without necessarily inserting any of its structure into or binding to the cell membrane.

It is also in the scope of the invention wherein the insoluble polymer, ceramic, gel, resin or metal oxide as defined above is provided useful for killing living cells without necessarily prior disruption of the cell membrane and lysis.

It is also in the scope of the invention wherein the insoluble polymer, ceramic, gel, resin or metal oxide as defined above is provided useful for causing a change of about <0.2 pH units of a physiological solution or body fluid surrounding a living cell while killing the living cell upon contact.

It is also in the scope of the invention wherein the insoluble polymer, ceramic, gel, resin or metal oxide as defined above is provided in the form of shapes, a coating, a film, sheets, beads, particles, microparticles or nanoparticles, fibers, threads, powders and a suspension of these particles.

All of the above mentioned materials and compositions of the current invention can be cast, molded or extruded and be used as particles in suspension, spray, cream, as membranes, coated films, fibers or fabrics, particles linked to or absorbed on fibers or fabrics, incorporated in filters etc.

### Example 1

### Improvement of Textiles by Ion-Exchange Materials with Antimicrobial (Antibacterial) Properties

### Materials and Methods

Raw materials (yarns and fabrics) subjected to treatment: Cotton; Cotton-spandex; Cotton-Lycra® and Cotton-viscose.

Materials for microbial (bacterial) inhibition: Amberlite™ CG-400-II beads (OH⁻-form) (Holland); Amberlite™ IR-120 II beads (H⁺-form) (Holland); NAFION (USA); acrylamide; immobilines (Sweden); ion exchange resins K1 (Russia); A1 (Russia); FIBAN K1 fibers (Belarus); FIBAN A1 fibers (Belarus);

Fabric treatment: (a) Suspension of ion-exchange materials (NAFION; immobilines) were incorporated into the fabric via standard textile dyeing technology by soaking in the solution and drying; (b) Solid ion-exchange material powders (Amberlite™; K1; A1; shredded FIBAN fibers) were uniformly spread on the fabric surface and treated with a hot iron.

Yarn treatment: (a) Suspension of ion-exchange materials (NAFION; immobilines) were incorporated into the material via standard textile dyeing technology; (b) Solid ion-exchange material powders (Amberlite™; K1; A1; shredded FIBAN fibers) were absorbed on the yarn fibers and heat treated with a hot iron to immobilize the powder particles; and (c) Threads of FIBAN's fibers were incorporated into yarn by heat treatment

### Results

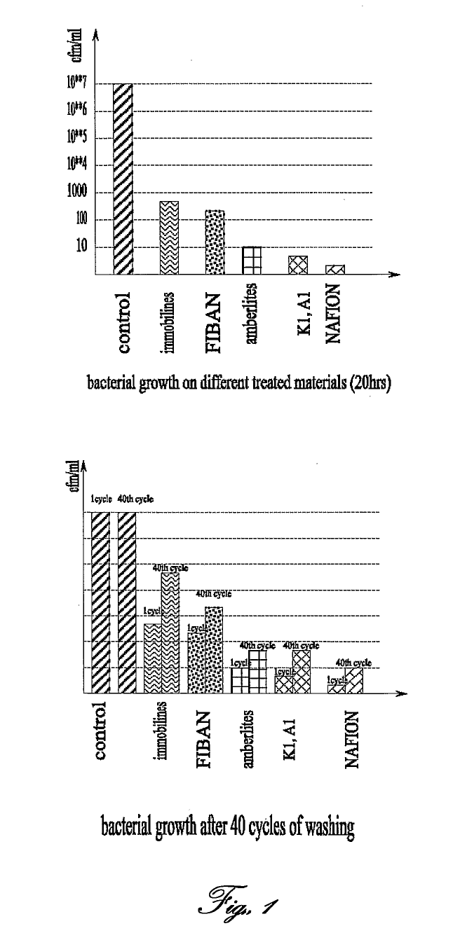

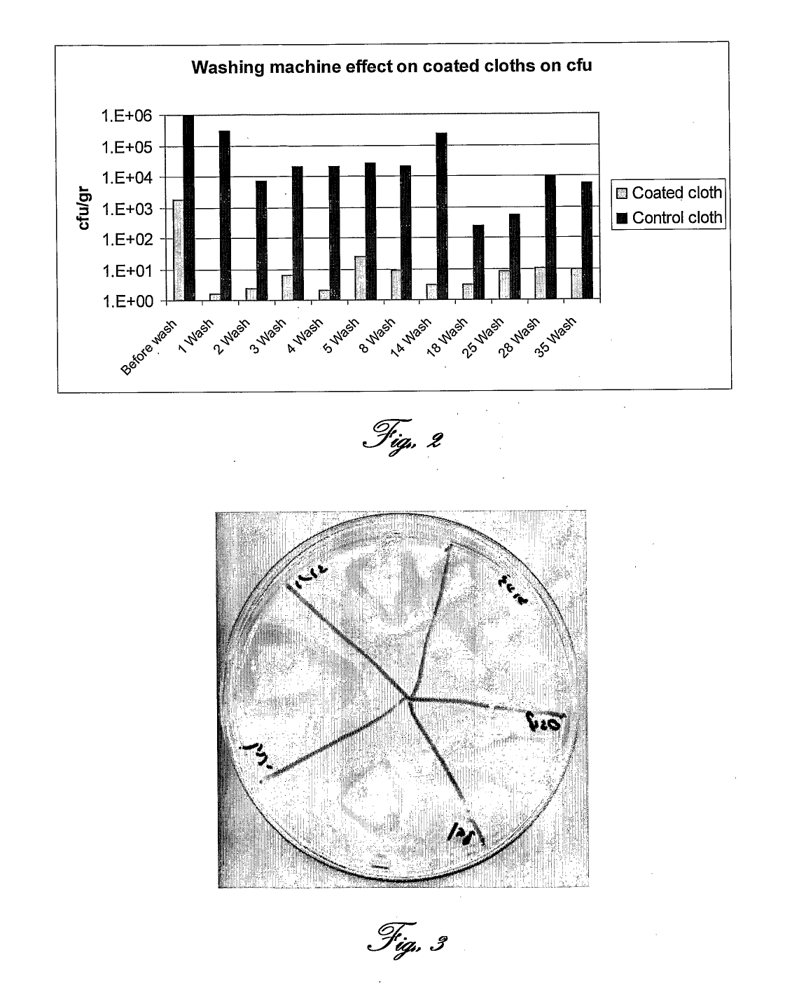

Reference is now made to FIG. 1, illustrating Bacterial counts (CFU/ml) in TSB in the absence or the presence of the various antimicrobial-treated fabrics.

General characteristics of fabrics and yarns after treatment: No changes in color, smell, mechanical and tactile properties of different textiles were observed after treatment with antimicrobial materials.

Washing resistance: Tested materials retained their antibacterial properties for up to 40 washing cycles in pure boiled water with only 1-order-of magnitude decrease in antimicrobial activity after 40 cycles.

Examination of antimicrobial efficiency: Series of fabric samples were placed in Tryptic Soy Broth (TSB) inoculated with microorganisms. Microbial growth was recorded after 2-3 days of incubation at 30-35° C. for bacteria and 20-24° C. for fungi by plating tenfold dilution on agar plates. Test microorganisms were grown in TSB medium without fabric served as a control (see FIG. 1).

### Example 2

### Formulation and Method for Coating Cotton Fabrics for Permanent Antimicrobial Property

### Materials and Methods

Amberlite™ CG-400-II beads (OH⁻-form) in a powder form was coated onto cotton fabrics by uniformly spread on the fabric surface and ironing under 120° C. At the end of the process, the change in total mass of fabric was ±2%.

FIBAN A1 fibers shredded into powder was coated onto cotton fabrics by uniformly spread on the fabric surface and ironing under 120° C. At the end of the process, the change in total mass of fabric was +2%.

### Results

Reference is now made to FIG. 2, showing the bacterial counts (CFU/gr of cloth) in treated and non treated cotton fabrics after several washing cycles.

Five pieces of cotton cloth have been coated as described above and was subject to several washing cycles of 1 hour and 18 min at 90° C. in a standard washing machine. Samples of 1 cm² of the cotton cloth were cut from the cloth and examined for bacterial count right before the 1^{st} washing cycle and then after each and every washing cycle. Antimicrobial activity was examined by exposure of the cloth sample to the air in the room for 10 minutes, vortexing the cloth in PBS (1 gr/100 ml) and plating 10-fold dilutions on TSA plates. Bacterial counts results are presented in Table 1 below.

TABLE 1
Bacterial counts (CFU/gr of cloth) in treated and non
treated cotton fabrics after several washing cycles

| | CFU/gr of | CFU/gr of |
|---|---|---|
| Washing cycle | Coated cloth | Control cloth |
| 0 | 1.8 × 10³ | 1 × 10⁶ |
| 1 | 1.67 | 3 × 10⁵ |
| 2 | 2.5 | 7.1 × 10³ |
| 3 | 6.5 | 2 × 10⁴ |
| 4 | 2 | 2 × 10⁴ |
| 5 | 25 | 2.6 × 10⁴ |
| 8 | 9 | 2 × 10⁴ |
| 14 | 3 | 2.4 × 10⁵ |
| 18 | 3 | 2.5 × 10² |
| 25 | 8 | 5.5 × 10² |
| 28 | 10.5 | 1 × 10⁴ |
| 35 | 10 | 5.6 × 10³ |

### Example 3

### Rendering a Non-Woven Disposable Fabric (Polypropylene Fabric) with Antimicrobial Properties

### Materials and Methods

### Antimicrobial Compositions:

Sulfonated silica (5%) (H+ form); SDS (10%); polyvinyl alcohol (5%); water. FIBAN K1; SDS (10%); polyvinyl alcohol (5%); water.

Coating method (1): soaking of the polypropylene fabric in the antimicrobial composition and drying. Mass change: 0.5%-1%; Temperature: 25° C.

Coating method (2): The polypropylene fabric is roll over a drum carrying a thin layer of antimicrobial composition collected from an underneath bath (see scheme below). Then after, the polypropylene fabric was dried by hot air.

### Results

Reference in now made to FIG. 3, demonstrating antimicrobial activity of non-woven disposable fabric (polypropylene fabric) treated by coating method 1.

Antimicrobial activity of non-woven polypropylene fabric treated with Sulfonated silica (5%) (H+ form); SDS (10%); polyvinyl alcohol (5%) using coating method 1 is demonstrated in FIG. 3 below. Small pieces of the treated fabric were placed on an agar plate inoculated with S. caseoliticus. Halos of bacterial growth inhibition can be observed around the various fabric samples.

1-26. (canceled)

27. Biocidic textiles and fabrics effective for killing cells, said biocidic textiles and fabrics comprising at least one charged polymer, said at least one charged polymer characterized, when in contact with a water-containing environment, as:
a. carrying strongly acid and/or strongly basic functional groups;
b. having a pH of less than about 4.5 or greater than about 8.0;
c. capable of generating an electrical potential within the confined volume of said cell sufficient to disrupt effectively the pH homeostasis and/or electrical balance within said confined volume of said cell; and,
d. being in a form chosen from the group consisting of (i) H⁺ and (ii) OH⁻;
wherein said charged polymer is adapted to preserve the pH of said cell's environment.

28. The biocidic textiles and fabrics of claim 27, further characterized, when said groups are accessible to water, as having a buffering capacity of about 20 to about 100 mM H⁺/L/pH unit.

29. The biocidic textiles and fabrics of claim 27, further characterized, when said groups are accessible to water, by at least one characteristic chosen from the group consisting of (a) sufficiently water-insoluble such that at least 99.9% remains undissolved at equilibrium; (b) sufficiently resistant to leaching such that the total concentration of material leached from said composition of matter into said water-containing environment does not exceed 1 ppm; (c) sufficiently inert such that at least one parameter of said water-containing environment chosen from the group consisting of (i) concentration of at least one predetermined water-soluble substance; (ii) particle size distribution; (iii) rheology; (iv) toxicity; (v) color; (vi) taste; (vii) smell; and (viii) texture remains unaffected according to preset conditions, said conditions adapted for and appropriate to said particular environment.

30. The biocidic textiles and fabrics of claim 27, further comprising at least one polymer chosen from the group consisting of (a) polyvinyl alcohol; (b) polystyrene sulfonate; and (c) polypropylene polystyrene-divinylbenzene.

31. The biocidic textiles and fabrics of claim 30, wherein at said at least one polymer contains at least one functional group chosen from the group consisting of SO₃H and H₂N(CH₃).

32. The biocidic textiles and fabrics of claim 27, further comprising hydrophilic additives chosen from the group consisting of proton conductive materials (PCMs) and hydrophilic polymers (HPs); further wherein said PCMs and HPs are chosen from the group consisting of (a) sulfonated tetrafluoroethylene copolymers; (b) sulfonated materials chosen from the group consisting of silica, polythion-ether sulfone (SPTES), styrene-ethylene-butylene-styrene (S-SEBS), polyether-ether-ketone (PEEK), poly(arylene-ether-sulfone) (PSU), polyvinylidene fluoride (PVDF)-grafted styrene, polybenzimidazole (PBI), and polyphosphazene; and (c) proton-exchange membranes made by casting a polystyrene sulfonate (PSSnate) solution with suspended micron-sized particles of cross-linked PSSnate ion exchange resin.

33. The biocidic textiles and fabrics of claim 27, comprising two or more charged polymers chosen from the group consisting of two-dimensional charged polymers and three-dimensional (3D) charged polymers, each of which of said charged polymers comprises materials containing cationic and/or anionic groups capable of dissociation and spatially organized in a manner adapted to preserve the pH of said water-containing environment according to preset conditions; said spatial organization chosen from the group consisting of (a) interlacing; (b) overlapping; (c) conjugating; (d) homogeneously mixing; (e) heterogeneously mixing; and (f) tiling.

34. The biocidic textiles and fabrics of claim 27, further comprising a surface with a given functionality and at least one external proton-permeable layer, each of which of said at least one external proton-permeable layers is disposed on at least a portion of said surface.

35. The biocidic textiles and fabrics of claim 27, comprising at least one charged polymer and at least one barrier adapted to prevent heavy ion diffusion.

36. The biocidic textiles and fabrics of claim 27, wherein said biocidic textiles and fabrics are in the form of a continuous barrier, said barrier selected from the group consisting of (a) 2D pads; (b) 3D pads; (c) sponges; (d) nonwoven webs; (e) membranes; (f) filters; (g) meshes; (h) nets; (i) sheet-like members; (j) any combination of the above.

37. The biocidic textiles and fabrics of claim 27, wherein said biocidic textiles and fabrics are in the form of an insert of dimensions adapted to allow mounting within an article of manufacture of predetermined dimensions, said mounting chosen from the group consisting of reversible mounting and permanent accommodation.

38. The biocidic textiles and fabrics of claim 27, further characterized by at least one of the following:
a. capacity for absorbing or releasing protons capable of regeneration;
b. buffering capacity capable of regeneration; and
c. proton conductivity capable of regeneration.

39. The biocidic textiles and fabrics of claim 27, adapted to avoid development of resistant mutations of said cells.

40. The biocidic textiles and fabrics of claim 27, further comprising at least one additive selected from the group consisting of hereinafter to one or more members of a group consisting of tea tree oil, rosin, abietic acid, terpenes, rosemary oil, zinc oxide, copper, mercury, silver salts, markers, biomarkers, dyes, pigments, radio-labeled materials, glues, adhesives, lubricants, medicaments, sustained release drugs, nutrients, peptides, amino acids, polysaccharides, enzymes, hormones, chelators, multivalent ions, emulsifying or de-emulsifying agents, binders, fillers, thickeners, factors, co-factors, enzymatic-inhibitors, organoleptic agents, liposomes, vesicles, magnetic materials, paramagnetic materials, biocompatibility-enhancing materials, biodegradation-enhancing materials, anticorrosive pigments, anti-fouling pigments, UV absorbers, blood coagulators, inhibitors of blood coagulation, or any combination thereof.

41. A method for increasing the rate of death of living cells and/or decreasing the rate of reproduction of living cells within a water containing-environment, comprising the steps of:
a. providing biocidic textiles and fabrics comprising at least one charged polymer, said at least one charged polymer characterized, when in contact with said water-containing environment, as:
i. carrying strongly acid and/or strongly basic functional groups;
ii. having a pH of less than about 4.5 or greater than about 8.0;
iii. capable of generating an electrical potential within the confined volume of said cell sufficient to disrupt effectively the pH homeostasis and/or electrical balance within said confined volume of said cell; and,
iv. being in a form chosen from the group consisting of (i) H⁺ and (ii) OH⁻; and,
b. placing said biocidic textiles and fabrics in contact with said water-containing environment.

42. The method of claim 41, wherein said step (a) further comprises the step of providing said charged polymer with predetermined water permeability, proton conductivity, and/or wetting characteristics, and further wherein said water permeability, proton conductivity, and/or wetting characteristics are provided by at least one substance selected from the group consisting of proton conductive materials (PCMs) and hydrophilic polymers (HPs).

43. The method of claim 42, wherein said step of providing said charged polymer with predetermined water permeability, proton conductivity, and/or wetting characteristics, and further wherein said water permeability, proton conductivity, and/or wetting characteristics are provided by at least one substance selected from the group consisting of proton conductive materials (PCMs) and hydrophilic polymers (HPs) further comprises a step of choosing said PCMs and HPs from the group consisting of (a) sulfonated tetrafluoroethylene copolymers; (b) sulfonated materials chosen from the group consisting of silica, polythion-ether sulfone (SPTES), styrene-ethylene-butylene-styrene (S-SEBS), polyether-ether-ketone (PEEK), poly(arylene-ether-sulfone) (PSU), polyvinylidene fluoride (PVDF)-grafted styrene, polybenzimidazole (PBI), and polyphosphazene; (c) proton-exchange membranes made by casting a polystyrene sulfonate (PSSnate) solution with suspended micron-sized particles of cross-linked PSSnate ion exchange resin; and derivatives thereof.

44. The method of claim 41, further comprising a step of providing at least one polymer chosen from the group consisting of (a) polyvinyl alcohol; (b) polystyrene sulfonate; and (c) polypropylene polystyrene-divinylbenzene.

45. The method of claim 41, further comprising a step of providing at that contains at least one functional group chosen from the group consisting of SO₃H and H₂N(CH₃).

46. The method of claim 41, further comprising a step of providing two or more charged polymers chosen from the group consisting of two-dimensional charged polymers and three-dimensional (3D) charged polymers, each of which of said charged polymers comprises materials containing cationic and/or anionic groups capable of dissociation and spatially organized in a manner adapted to preserve the pH of said water-containing environment according to preset conditions; said spatial organization chosen from the group consisting of (a) interlacing; (b) overlapping; (c) conjugating; (d) homogeneously mixing; (e) heterogeneously mixing; and (f) tiling.

47. The method of claim 46, further comprising a step of spatially organizing each of said functional groups in a manner selected from (a) interlacing; (b) overlapping; (c) conjugating; (d) homogeneously mixing; (e) heterogeneously mixing; and (f) any combination of the above.

48. The method of claim 41, further comprising an additional step of providing said charged polymer with an ionomeric barrier layer comprising a sulfonated tetrafluoroethylene copolymer, said barrier adapted to avoid heavy ion diffusion.

49. A method of production of a biocidic textiles and fabrics effective for killing cells, comprising the steps of:
a. providing at least one charged polymer, said at least one charged polymer characterized, when in contact with said water-containing environment, as:
i. carrying strongly acid and/or strongly basic functional groups;
ii. having a pH of less than about 4.5 or greater than about 8.0;
iii. capable of generating an electrical potential within the confined volume of said cell sufficient to disrupt effectively the pH homeostasis and/or electrical balance within said confined volume of said cell; and,
iv. being in a form chosen from the group consisting of (i) H⁺ and (ii) OH⁻; and,
b. incorporating said charged polymer into a fabric.

50. The method of claim 49, wherein said step of incorporating said charged polymer into a fabric comprises further steps of:
c. soaking said fabric in a suspension of said charged polymer in a liquid; and
d. drying.

51. The method of claim 49, wherein said step of incorporating said charged polymer into a fabric comprises further steps of:
c. spreading said charged polymer on a surface of said fabric; and,
d. treating said fabric with a hot iron.

52. The method of claim 49, wherein said step of incorporating said charged polymer into a fabric comprises further steps of:
c. coating a drum with a layer of said charged polymer, said layer obtained from a suspension of said charged polymer in liquid;
d. rolling said fabric over said drum; and
e. drying said fabric.

53. The method of claim 49, wherein said step of providing at least one charged polymer characterized, when said groups are accessible to water, by at least one characteristic chosen from the group consisting of (a) sufficiently water-insoluble such that at least 99% remains undissolved at equilibrium; (b) sufficiently resistant to leaching such that the total concentration of material leached from said composition of matter into said water-containing environment does not exceed 1 ppm; (c) sufficiently inert such that at least one parameter of said water-containing environment chosen from the group consisting of (i) concentration of at least one predetermined water-soluble substance; (ii) particle size distribution; (iii) rheology; (iv) toxicity; (v) color; (vi) taste; (vii) smell; and (viii) texture remains unaffected according to preset conditions, said conditions adapted for and appropriate to said particular environment.

54. The method of claim 49, wherein said step of providing at least one charged polymer further comprises the step of providing a charged polymer characterized, when said groups are accessible to water, as being sufficiently inert such that the toxicity of said water-containing environment as defined by at least one parameter chosen from the group consisting of (a) LD₅₀ and (b) ICT₅₀ remains unaffected according to preset conditions, said conditions adapted for and appropriate to said particular environment.

55. The method of claim 49, further comprising steps of:
c. providing at least one external proton-permeable surface with a predetermined functionality; and
d. layering at least a portion of said proton-permeable surface with at least one of said charged polymer.

56. The method of claim 49, wherein said step of providing at least one polymer further comprises a step of providing at least one polymer chosen from the group consisting of (a) polyvinyl alcohol; (b) polystyrene sulfonate; and (c) polypropylene polystyrene-divinylbenzene.

57. The method of claim 49, wherein said step of providing at least one polymer that contains at least one functional group chosen from the group consisting of SO₃H and H₂N(CH₃).

58. A method for regenerating the biocidic properties of a biocidic textiles and fabrics as defined in claim 27, said method comprising at least one step chosen from the group consisting of (a) regenerating said biocidic textiles and fabrics's proton absorbing and/or releasing capacity; (b) regenerating said biocidic textiles and fabrics's buffering capacity; and (c) regenerating the proton conductivity of said biocidic textiles and fabrics.
